(19) United States
(12) Patent Application Publication
(10) Pub. No.: US 2009/0089779 A1
(43) Pub. Date: Apr. 2, 2009

(54) APPARATUS SYSTEM AND METHOD FOR CUSTOMIZING A COMPUTING ENVIRONMENT

(76) Inventors: Evelyn Thompson Brengle, Cedar Park, TX (US); John Thomas Olson, Tucson, AZ (US)

Correspondence Address: Kunzler & McKenzie, 8 EAST BROADWAY, SUITE 600, SALT LAKE CITY, UT, 84111, US

(21) Appl. No.: 11/864,160

(22) Filed: Sep. 28, 2007

(51) Int. Cl. G06F 9/445

(52) U.S. Cl. 717/177

(57) ABSTRACT

An apparatus, system, and method are disclosed for customizing a computing environment. An exportroot image, comprising a base operating system, may be sent to an application provider with a customization script. The customization script allows the application provider to develop a particular application to be used with the exportroot image in a desired computing environment. The provider can modify the customization script to make appropriate customizations to the exportroot image and base operating system as required by the particular application. The customization script is also capable of detecting the hardware architecture of the computer to install appropriate configuration files. The customization script expedites developing a computing environment by eliminating the need to send the exportroot image back to its provider to make modifications.

### BACKGROUND OF THE INVENTION

1. Field of the Invention

This invention relates to computer systems and more particularly relates to customizing computer environments for use on computer systems.

2. Description of the Related Art

An exportroot image is used to provide a base starting point for developing and compiling software to be used in a computing environment. The exportroot image typically includes an operating system environment where the developed and compiled software is to be run. A disconnect often exists between a provider of the exportroot image and a provider of a software application. That is, as the software provider compiles code to be run with the exportroot image, any change needing to be made to the exportroot image must be made by the exportroot image provider. As a result, the exportroot image is often sent back and forth between providers until the software development is complete and compiles appropriately on the exportroot image.

FIG. 1 depicts a current method of a third-party developing software using an exportroot image developed by a separate company or division. A provider provides 110 an exportroot image. The exportroot image is designed to install an operating system environment for use in a computing environment. However, the operating system environment is not specialized with respect to the computing environment since the provider of the exportroot image does not know what the intended environment will be. Some examples of the computing environment are a cash register environment, a server environment, or the like.

The provider of the exportroot image sends 120 the exportroot image to the third-party so the third-party can provide 130 a particular application and specialized computing environment. The exportroot image contains a generic operating system environment. As the third-party particular application provider develops the particular application, certain modifications to the exportroot image may need to be made. Upon ascertaining 140 that a modification is required, the exportroot image is returned to the exportroot image provider for the modifications to be made. The exportroot image provider again develops the exportroot image 110 according to the third-party specifications.

Upon ascertaining 140 that a modification is not required, the particular application may be packaged 150 with the exportroot image. This package may be a compressed package, an installer package or the like. The package may then be distributed to an intended recipient to install the application and customized computing environment.

Customizing a computing environment using an exportroot image in conjunction with third-party vendors currently requires the exportroot image to be sent back to the exportroot image provider one or more times during the creation of the customized computing environment. Time is spent trying to modify the exportroot image according to the third-party's specifications. On the chance that multiple modifications need to be made at different times, even more time is consumed before the project can reach completion.

### SUMMARY OF THE INVENTION

The present invention has been developed in response to the present state of the art, and in particular, in response to the problems and needs in the art that have not yet been fully solved by currently available customization means and methods. Accordingly, the present invention has been developed to provide an apparatus, system, and method for customizing a computing environment that overcomes many or all of the above-discussed shortcomings in the art.

The apparatus to provide a customized computing environment is provided with a logic unit containing a plurality of modules configured to functionally execute the necessary steps of customizing a computing environment. These modules in the described embodiments include an installation module and an execution module comprising a modification module, a load module, an application module, a creation module, an enable module, and a restriction module.

The apparatus, in one embodiment, is configured to install a base operating system on a computer. The computer may be one component of a larger computing system. The apparatus is further configured to execute a customization script. The customization script customizes an exportroot image. The exportroot image may include the base operating system and other configuration files. When the customization script is executed, it modifies one or more configuration settings of the base operating system. A configuration setting may be attributable to a configuration file associated with the base operating system. The modification facilitates development and compilation of a particular application with the base operating system.

The customization script also loads one or more configuration files on the computer and installs the particular application to produce the computing environment. In one embodiment, the customization script creates selected users or groups to be used with the particular application or with the installation of the particular application. The selected users or groups, if not needed after the installation, can be removed from the configuration. The customization module is further configured to enable the users or groups to execute the particular application. This may include executing the customization script after installation or executing certain scripts of the particular application during installation. Likewise, the customization script may also restrict the permissions of the users or groups from adversely affecting the particular application and associated computing environment.

In one embodiment, the customization script is derived from an example script of a provider of the particular application. In another embodiment, the customization script is provided by a provider of the base operating system. A deployer of the particular application makes modifications to the customization script to facilitate installation of the particular application on the base operating system. Neither the base operating system nor the exportroot image needs to be shipped back to the provider of the exportroot image for modification.

In a further embodiment, the apparatus is configured to detect a hardware configuration for the computer. Detection of the hardware configuration facilitates selection of configuration files associated with a particular configuration. The apparatus may be configured to extract the base operating system and customization script from an install package.

A system of the present invention is also presented to provide a customized computing environment. The system, in one embodiment, includes a computer, a base operating system, and a customization script as described above and elsewhere in this specification.

A method of the present invention is also presented for providing a customized computing environment. The method in the disclosed embodiments substantially includes the steps necessary to carry out the functions presented above with respect to the operation of the described apparatus and system. In one embodiment, the method includes installing a base operating system on a computer and executing a customization script as described above and elsewhere in this specification.

The customization script is configured to modify at least one configuration setting of the base operating system. The customization script also loads a configuration file on the computer. The configuration file provides a computing environment conducive to installing and executing a particular application. The customization script installs the particular application, creates selected users or groups, enables the selected users or groups to execute the particular application, and restricts the selected users or groups from adversely affecting the particular application and associated computing environment.

The method also may include the customization script derived from either the provider of the particular application or the provider of the base operating system. The customization script is modifiable to allow the provider of the particular application to make adjustments needed by the particular application. The customization script may also detect a hardware configuration for the computer and select a configuration files that corresponds to the hardware configuration for the computer. In one embodiment, the method includes extracting the base operating system and customization script from an install package.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic flow chart diagram illustrating a typical prior art method for customizing a computing environment;

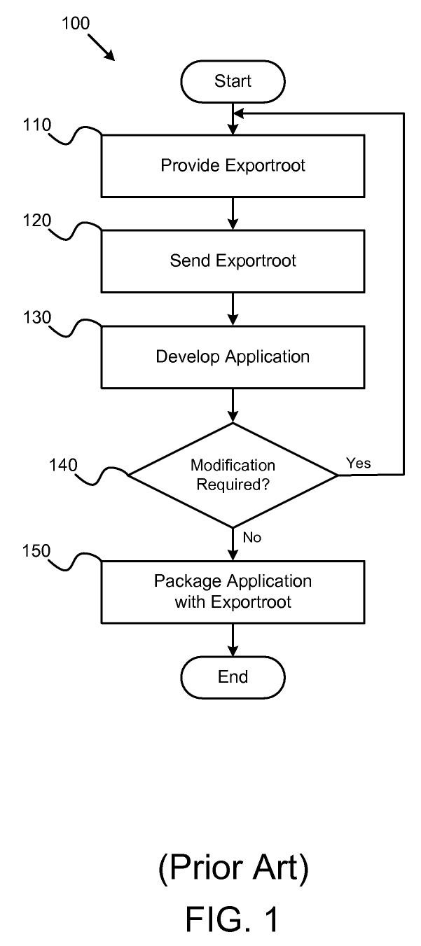

FIG. 2 is a schematic block diagram illustrating one embodiment of an apparatus for customizing a computing environment in accordance with the present invention;

FIG. 3 is a schematic block diagram illustrating one embodiment of an install package in accordance with the present invention;

FIG. 4 is a schematic flow chart diagram illustrating one embodiment of a method for customizing a computing environment in accordance with the present invention;

FIG. 5 is a schematic flow chart diagram illustrating one embodiment of a customization script configuration in accordance with the present invention; and

FIG. 6 is a schematic flow chart diagram illustrating one embodiment of a method for customizing a computing environment in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of facilitating execution of a program of machine-readable instructions on a digital processing apparatus. For example, a computer readable medium may be embodied by a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

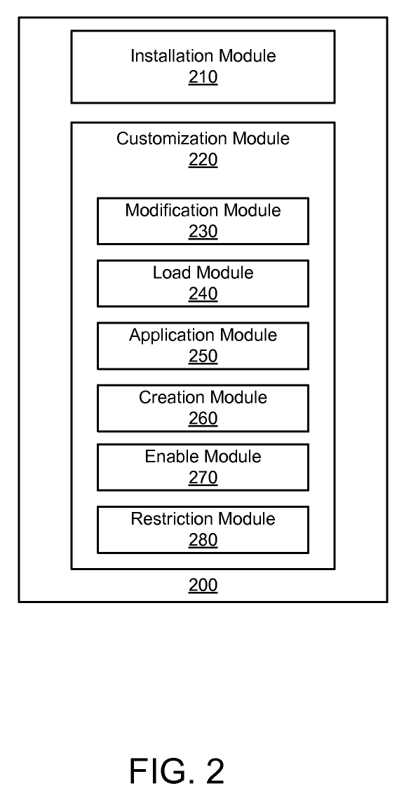

FIG. 2 depicts one embodiment of an apparatus for customizing a computing environment in accordance with the present invention. The apparatus 200 includes an installation module 210 and a customization module 220 which includes a modification module 230, a load module 240, an application module 250, a creation module 260, an enable module 270, and a restriction module 280. The depicted apparatus 200 enables customization a computing environment.

In one embodiment, the installation module 210 is configured to install abase operating system on a computer. In one embodiment, the base operating system is installed prior to being customized by the customization module.

The customization module 220 may be configured to execute a sequence of configuration steps to facilitate proper completion of the computing environment. The modification module 230 may modify one or more configuration settings of the base operating system or a particular application. The configuration settings may reside in one or more configuration files of the base operating system or the particular application. The modifications to the settings may be used to facilitate development of the particular application designed to be installed on the base operating system, which combination may form the computing environment.

The load module 240 may load one or more configuration files on the computer. The one or more configuration files may be configured to provide a computing environment conducive to executing the particular application. The application module 250 may be configured to install the particular application. In one embodiment, the application module 250 is configured to execute on an existing computing environment, similar to a system upgrade. The application module 250 may be configured to execute on a new installation of a computing environment, similar to an install program.

The creation module 260 may create objects, users, and groups necessary to achieve a computing environment conducive to executing the particular application. The objects may include files, folders, resources, or the like.

The enable module 270 configures the objects with permissions to perform one or more specified tasks. For example, permissions may be given to users or groups requiring permission to install or operate the particular application.

The restriction module 280 may place restrictions on particular objects from performing certain tasks or having certain tasks performed on them. In one embodiment, the restriction module 280 restricts selected users or groups from adversely affecting the particular application. Similarly, the restriction module 280 may restrict users or groups from adversely affecting the computing environment.

In certain embodiments, an example script is provided to supply a baseline for deriving the customization script particular to the needs of the application provider. In some embodiments, the example script is provided by a provider of the exportroot image.

In one embodiment, a detection module detects a hardware architecture of the computer. Detection of the hardware architecture facilitates correct selection of one or more configuration files. The detection module may query a basic input/output system (BIOS) of the computer to discover the hardware architecture. In one embodiment, the detection module executes a command such as “dmicode” to query the BIOS.

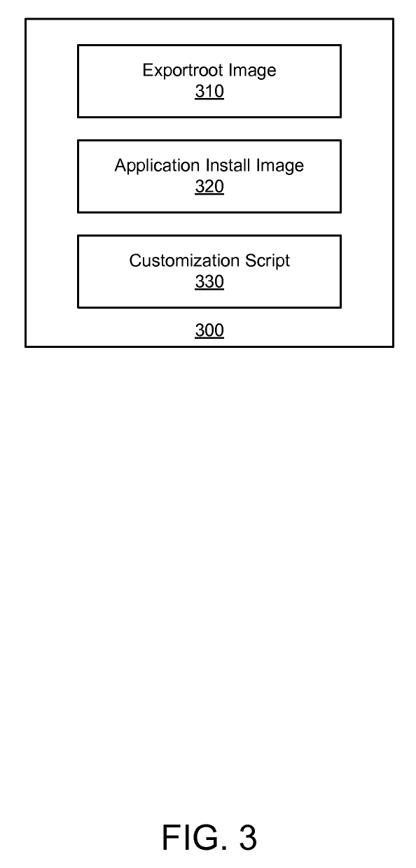

FIG. 3 depicts one embodiment of an install package in accordance with the present invention. The install package 300 includes an exportroot image 310, a particular application install image 320, and a customization script 330. The depicted install package 300 is one embodiment of a distributable package for installing a computing environment.

In one embodiment, the exportroot image 310 comprises the base operating system. The exportroot image 310 may include configuration files. Some configuration files may be particular to a specific hardware configuration. The configuration files may include configuration settings that control the behavior of the base operating system. In one embodiment, the exportroot image 310 is developed by a provider of the operating system, who may not be familiar with the intended computing environment.

The particular application install image 320 may be developed for a specific computing environment. In one embodiment, the particular application install image 320 is developed by a provider of the particular application. The provider of the particular application install image 320 may not be familiar with the provider of the operating system. The particular application install image 320 may be developed and compiled to run on the exportroot image 310 to create a computing environment.

The customization script 330 may provide an easy mechanism for modifying the behavior of the installed exportroot image 310. In one embodiment, the customization script 330 is developed by a provider of the exportroot image. In another embodiment, the customization script 330 is developed by a provider of the particular application install image 320. The customization script 330 may be derived from an example script.

The example script may be provided by the provider of the exportroot image, the provider of the particular application, or another party. As the provider of the particular application requires a change to the behavior of the installed exportroot image, the provider of the particular application may make the necessary modification in the customization script to modify the exportroot image. Allowing the provider of the particular application to make a modification to the exportroot image expedites the customization process.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

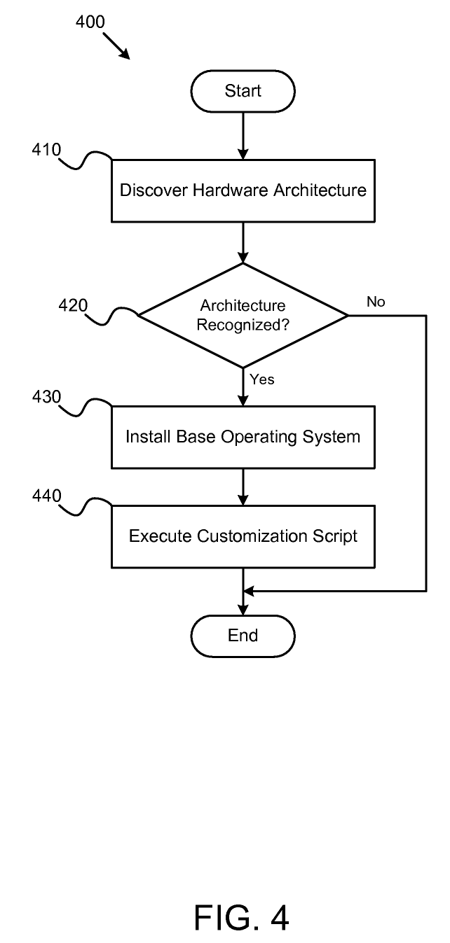

FIG. 4 is a schematic flow chart diagram of a method for customizing a computing environment in accordance with the present invention. The method 400 includes discovering 410 a hardware architecture, ascertaining 420 if the hardware architecture is recognized, installing 430 a base operating system, and executing 440 a customization script. The method 400 demonstrates one embodiment for customizing a computing environment.

Discovering 410 the hardware architecture may include querying a basic input/output system (BIOS) of a computer. In one embodiment, discovering 410 the hardware architecture includes querying the base operating system. Discovering 410 the hardware architecture may include running a command such as “dmicode.”

In one embodiment, ascertaining 420 if the hardware architecture is recognized includes comparing the results from discovering 410 with a known architecture type list. If the hardware architecture is recognized, then the method 400 proceeds to installing 430 the base operating system and executing 440 the customization script. In the depicted embodiment, installing 430 occurs before executing 440. In another embodiment, executing 440 occurs before installing 430. In yet another embodiment, installing 430 occurs concurrently with executing 440.

In one embodiment, executing 440 the customization script includes loading the proper configuration files onto a computer. The proper configuration files may depend on the hardware architecture. For example, the configuration file may include x86 configuration files, X-Windows configuration files, or the like.

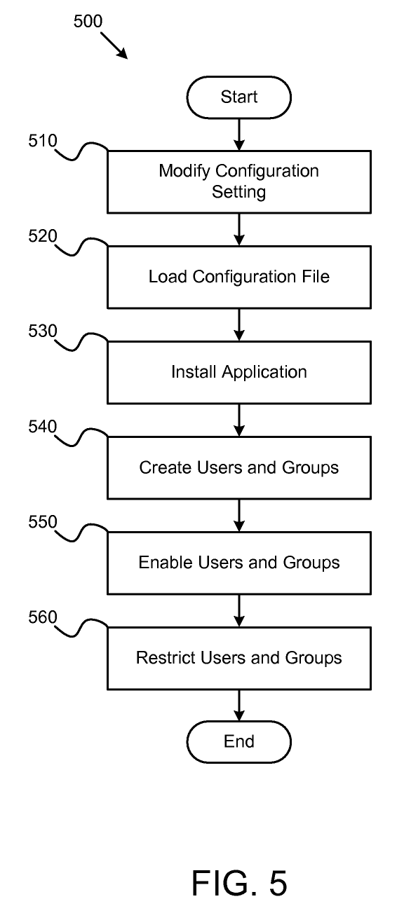

FIG. 5 is a schematic flow chart diagram of a customization method in accordance with the present invention. The method 500 includes modifying 510 one or more configuration settings, loading 520 one or more configuration files, installing 530 a particular application, creating 540 users and groups, enabling 550 the users and groups, and restricting 560 the users and groups. The customization method 500 is one example of the operation 440 depicted in FIG. 4.

In one embodiment, modifying 510 one or more configuration settings includes making modifications to settings affecting a base operating system or the particular application. The configuration settings may reside in one or more configuration files of the base operating system or the particular application. The modifications to the settings may be used to facilitate deployment of the particular application designed to be installed on the base operating system.

Loading 520 one or more configuration files may include loading one or more configuration files on the computer. The one or more configuration files may be configured to provide a computing environment conducive to executing the particular application. Installing 530 the particular application may include installing on an existing computing environment or installing on a new installation of the base operating system.

Creating 540 users or groups may include creating users or groups required to install components in the computing environment, including the particular application. Enabling 550 the users or groups may include granting permissions to the users or groups necessary to execute the particular application. In one embodiment, enabling 550 includes granting the users or groups permission to install the particular application. Restricting 560 the users or groups may include denying users or groups permissions that may adversely affect the particular application and associated computing environment.

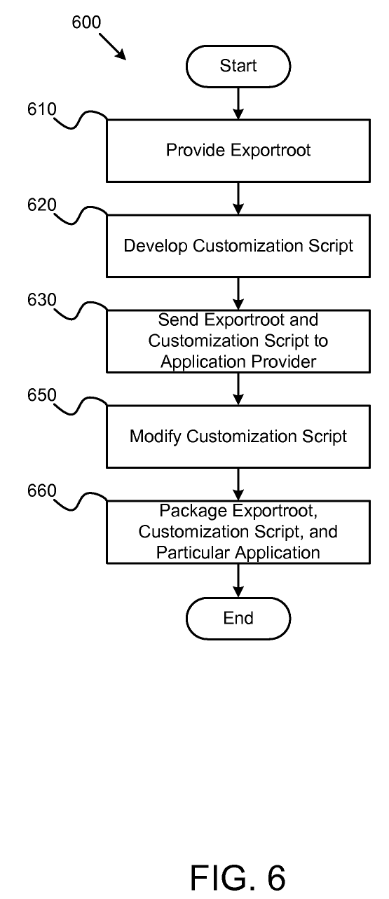

FIG. 6 is a schematic flow chart diagram of a method for customizing a computing environment in accordance with the present invention. The method 600 includes providing 610 an exportroot image; developing 620 a customization script; sending 630 the exportroot image and customization script to an application provider; modifying 650 the customization script; and packaging 660 the exportroot image, customization script, and particular application. The method 600 is one embodiment for customizing a computing environment.

Providing 610 an exportroot image may include creating a base operating system and associated environment. Since a provider of the exportroot image may not know the specifics of the intended computing application, the base operating system environment may be a generic computing environment.

In one embodiment, developing 620 a customization script includes identifying configuration settings capable of modification and assigning a modification command for each setting. The modification command may be altered at any time depending on need. In one embodiment, developing 620 the customization script includes using an example script supplied by a provider of a particular application. The example script may indicate users or groups to be created, configuration settings to be altered, users or groups to be restricted, or the like. The customization script may be modified by the provider of the exportroot image or the provider of the particular application.

Sending 630 the exportroot image and customization script to an application provider may include packaging the two together in a software package. The software package may be in a compressed format. The exportroot image or customization script may be extracted from the software package. In the depicted embodiment, the exportroot image and customization script need only be sent to the provider of the particular application once since the provider of the particular application may modify the customization script to make any necessary modifications to the exportroot image.

In one embodiment, modifying 650 the customization script includes adding code to the customization script to perform a particular action. The particular action may be performed directly on the exportroot image. In one embodiment, the particular action may be performed on the base operating system at install time. In another embodiment, the particular action may be performed on an existing operating system and computing environment. In the depicted embodiment, the provider of the particular application modifies the customization script to prevent sending the exportroot image back to the provider of the exportroot image for modification.

Packaging 660 the exportroot image, the customization script, and the particular application may include combining the three software components into an installable software release. Packaging 660 may facilitate installation of the computing environment at a different location than a development site. The provider of the particular application may initiate packaging 660. In one embodiment, the provider of the exportroot image initiates packaging. In one embodiment, packaging 660 provides a distributable installer to execute the exportroot image, customization script, and particular application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method to provide a customized computing environment, the method: comprising:
installing a base operating system on a computer; and
executing a customization script configured to:
modify at least one configuration setting of the base operating system,
load a configuration file on the computer, the configuration file configured to provide a computing environment conducive to executing a particular application;
install the particular application,
create selected users or groups,
enable the selected users or groups to execute the particular application, and
restrict the selected users or groups from adversely affecting the particular application and associated computing environment.

2. The method of claim 1, wherein the customization script is derived from an example script by a provider of the particular application.

3. The method of claim 2, wherein the example script is provided by a provider of the base operating system.

4. The method of claim 1, wherein the customization script is further configured to detect a hardware configuration for the computer and select a configuration file that corresponds to the hardware configuration for the computer.

5. The method of claim 1, further comprising extracting the base operating system and customization script from an install package.

6. An apparatus to provide a customized computing environment, the apparatus comprising:
an installation module configured to install a base operating system on a computer; and
an execution module configured to execute a customization script comprising:
a modification module configured to modify at least one configuration setting of the base operating system;
a load module configured to load a configuration file on the computer, the configuration file configured to provide a computing environment conducive to executing a particular application;
an application module configured to install the particular application;
a creation module configured to create selected users or groups;
an enable module configured to enable the selected users or groups to execute the particular application, and
a restriction module configured to restrict the selected users or groups from adversely affecting the particular application and associated computing environment.

7. The apparatus of claim 6, wherein the customization script is derived from an example script by a provider of the particular application.

8. The apparatus of claim 7, wherein the example script is provided by a provider of the base operating system.

9. The apparatus of claim 6, further comprising a detection module configured to detect a hardware configuration for the computer and select a configuration file that corresponds to the hardware configuration for the computer.

10. The apparatus of claim 6, further comprising an extraction module configured to extract the base operating system and customization script from an install package.

11. A system to provide a customized computing environment, the system comprising:
a computer;
a base operating system; and
a customization script configured to:
modify at least one configuration setting of the base operating system;
load a configuration file on the computer, the configuration file configured to provide a computing environment conducive to executing a particular application,
install the particular application,
create selected users or groups,
enable the selected users or groups to execute the particular application, and
restrict the selected users or groups from adversely affecting the particular application and associated computing environment.

12. The system of claim 11, wherein the customization script is derived from an example script by a provider of the particular application.

13. The system of claim 12, wherein the example script is provided by a provider of the base operating system.

14. The system of claim 11, wherein the customization script is further configured to detect a hardware configuration for the computer and select a configuration file that corresponds to the hardware configuration for the computer.

15. The system of claim 11, further comprising an install package, wherein the base operating system and customization script are inserted and extracted.

16. A computer readable medium tangibly embodying a program of machine-readable instructions executable by a digital processing apparatus to perform operations to provide a customized computing environment, the operations comprising:
installing a base operating system on a computer; and
executing a customization script configured to:
modify at least one configuration setting of the base operating system,
load a configuration file on the computer, the configuration file configured to provide a computing environment conducive to executing a particular application;
install the particular application,
create selected users or groups,
enable the selected users or groups to execute the particular application, and
restrict the selected users or groups from adversely affecting the particular application and associated computing environment.

17. The computer readable medium of claim 16, wherein the customization script is derived from an example script by a provider of the particular application.

18. The computer readable medium of claim 17, wherein the example script is provided by a provider of the base operating system.

19. The computer readable medium of claim 16, wherein the customization script is further configured to detect a hardware configuration for the computer and select a configuration file that corresponds to the hardware configuration for the computer.

20. The computer readable medium of claim 16, wherein the operation further comprises extracting the base operating system and customization script from an install package.
